(19) United States
(12) Patent Application Publication
(10) Pub. No.: US 2008/0129532 A1
(43) Pub. Date: Jun. 5, 2008

(54) System and Method for Activating a Mobile Device

(76) Inventor: David BELLOWS, Wantagh, NY (US)

Correspondence Address: FAY KAPLUN & MARCIN, LLP, 150 BROADWAY, SUITE 702, NEW YORK, NY, 10038, US

(21) Appl. No.: 11/564,941

(22) Filed: Nov. 30, 2006

(51) Int. Cl. H04Q 1/00

(52) U.S. Cl. 340/825; 340/686.1; 340/686.6

(57) ABSTRACT

A mobile device includes a function module and a triggering arrangement generating a signal to activate the function module in response to detecting a triggering condition. The triggering condition is at least one of a change in an orientation of the device and a time relative to a previous activation of the function module.

### FIELD OF INVENTION

The present application generally relates to systems and methods for activating a mobile device.

### BACKGROUND INFORMATION

Mobile devices (e.g., barcode scanners, image-based scanners, RFID readers, radio transceivers, video recorders, etc.) are used in a multitude of situations for both personal and business purposes. These devices often utilize a manually operated triggering mechanism such as a pushable button, a sliding switch, a touch-panel, etc. The triggering mechanism requires a user to perform an additional action in order to effect triggering. For example, if the triggering mechanism is thumb-activated, the additional action may comprise moving a thumb from a resting position to a triggering position, then manually engaging the triggering mechanism. If the user's hand is occupied with another task, performing the additional action may interrupt or force the user to abandon the task. In some instances, this is merely an inconvenience. However, in situations where the task is mission-critical or time-sensitive, this may be unacceptable. Furthermore, the additional action may be so unnatural that over an extended period of use, the user may experience discomfort or injury. Still other users may be unable to even perform the additional action because of physical defects or disabilities. Accordingly, a need has developed for ways to make mobile devices easier to operate.

### SUMMARY OF THE INVENTION

The present invention relates to a mobile device comprising a function module and a triggering arrangement generating a signal to activate the function module in response to detecting a triggering condition. The triggering condition is at least one of a change in an orientation of the device and a time relative to a previous activation of the function module.

The present invention also relates to a method comprising the step of detecting a triggering condition that includes at least one of a change in an orientation of a mobile device relative to a body part of a user and a change in an orientation of the device relative to a previous orientation of the device. The method further includes the step of generating a signal to activate a function of the device in response to detecting the triggering condition.

### BRIEF DESCRIPTION OF THE DRAWINGS

FIG. 1 shows a block diagram of an exemplary embodiment of a mobile device according to the present invention.

FIG. 2A shows a mobile device in an exemplary resting position.

FIG. 2B shows the mobile device of FIG. 2A in an exemplary operational position.

FIG. 3 shows an exemplary embodiment of a mobile device according to the present invention.

FIG. 4 shows an exemplary method for activating the device of FIG. 3 according to the present invention.

FIG. 5A shows an exemplary embodiment of a second mobile device according to the present invention.

FIG. 5B shows the device of FIG. 5A being activated according to the present invention.

FIG. 6 shows an exemplary method for activating the device of FIGS. 5A and 5B according to the present invention.

FIG. 7 shows an exemplary embodiment of a third mobile device according to the present invention.

FIG. 8 shows an exemplary method for activating the device of FIG. 7 according to the present invention.

FIG. 9 shows an exemplary method for training a mobile device according to the present invention.

### DETAILED DESCRIPTION

The present invention may be further understood with reference to the following description and the appended drawings, wherein like elements are provided with the same reference numerals. The present invention relates to systems and methods for activating (e.g., triggering a function of) a mobile device. Various embodiments of the present invention will be described with reference to a wearable radio-frequency identification (“RFID”) reader. However, those skilled in the art will understand that the present invention may be implemented with any mobile device that is capable of being triggered and where the triggering may activate any functionality included in the mobile device.

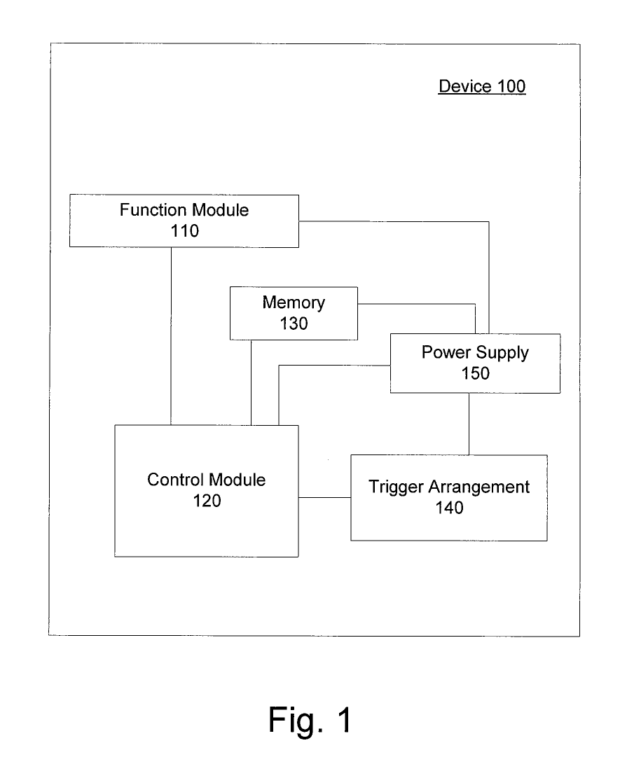

FIG. 1 shows a block diagram of an exemplary embodiment of a mobile device 100 according to the present invention. The device 100 may be used to implement any of the systems and methods for triggering that will be described below. As shown in FIG. 1, the device 100 may include a function module 110 communicatively coupled to a control module 120. The function module may include one or more electrical and/or mechanical components for executing a function of the device 100. For example, if the device 100 is an RFID reader, the function module 110 may include an RF transmitting and receiving arrangement for reading RF tags. The function module 110 may also include software components for controlling operation of the electrical/hardware components.

The control module 120 regulates the operation of the device 100 by facilitating communications between the various components of the device 100. The control module 120 may, for example, include a processor such as a microprocessor, an embedded controller, an application-specific integrated circuit, a programmable logic array, etc. The processor may perform data processing, execute instructions and direct a flow of data between devices coupled to the control module 120 (e.g., a memory 130 and a trigger arrangement 140). As explained below, the control module 120 may receive an input from the trigger arrangement 140 and in response, may activate the device 100 by instructing the function module 110 to perform a specific function (e.g., transmitting an RF query signal).

The memory 130 may be any storage medium capable of being read from and/or written to. The memory 130 may include any combination of volatile and/or nonvolatile memory (e.g., RAM, ROM, EPROM, Flash, etc.) The memory 130 may also include one or more storage disks such as a hard drive. In one embodiment, the memory 130 is a temporary memory in which data may be temporarily stored until it is transferred to a permanent storage location (e.g., uploaded to a personal computer). In another embodiment, the memory 130 may be a permanent memory comprising a database.

The trigger arrangement 140 may include any combination of hardware and/or software for detecting a user input and producing a corresponding output signal that is received by the control module 120. The trigger arrangement 140 may be directly or indirectly coupled to the control module 120. Direct coupling may comprise one or more wired connections between the trigger arrangement 140 and the control module 120. Indirect coupling may be achieved by any number of conventional coupling mechanisms, such as capacitive and inductive coupling, and relay switching.

As will be described in further detail below, exemplary embodiments of the present invention may utilize passive triggering. That is, the exemplary embodiments do not utilize conventional manual triggering mechanisms such as a gun-style trigger, a pushable button, a mechanical switch, etc. Accordingly, the trigger arrangement 140 may include a passive triggering mechanism that produces the output signal in response to the user input. The output signal may be analog or digital and may include a range of voltage and/or current values. In addition, the output signal may be either a continuous signal or an intermittent signal of fixed or variable duration. For example, if the output signal is the continuous signal, the control module 120 may periodically sample the output signal. If the output signal is the intermittent signal, it may announce itself to the control module 120.

The power supply 150 provides power to each component coupled thereto and may include a built-in power source (e.g., a battery) that may be rechargeable and/or replaceable. In addition or in alternative to the built-in source, the power supply 150 may include an arrangement for receiving an external power source (e.g., a AC-to-DC converter). As shown in FIG. 1, the power supply 150 may be coupled to each of the function module 110, the control module 120, the memory 130 and the trigger arrangement 140. Thus, the power supply 150 may provide power to each of these components.

Various embodiments of the present invention will now be described with reference to a strapped RFID reader. Strapped readers may be used in situations where it is desirable to operate a reader without requiring the user to hold it. This allows the user to use his hand for other purposes such as picking up an object, typing on a keyboard, writing, etc.

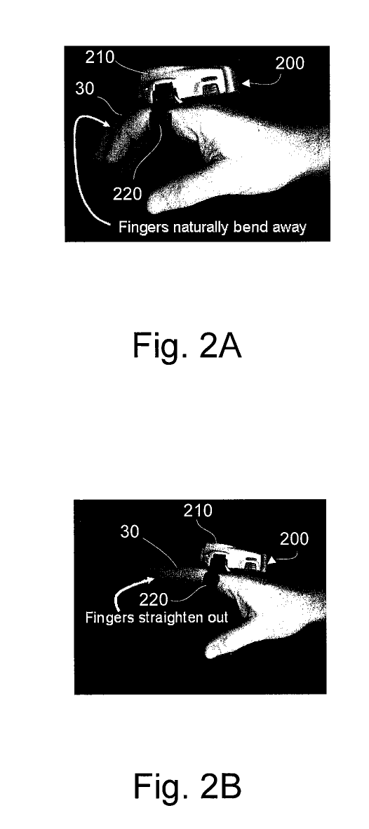

FIG. 2A shows an RFID reader 200 in a resting position in which the user's hand is in a natural resting position. The reader 200 is coupled to a strap 220 worn over one or more fingers 30 of the user. The reader 200 may be positioned over a proximal joint of the finger(s) such that a housing 210 of the reader 200 extends proximally over a back of the user's hand. When the reader 200 is worn in the manner illustrated in FIG. 2A, the fingers 30 naturally bend away from the reader 200 as long as the user's hand remains relaxed.

FIG. 2B shows the reader 200 in an operational position in which the user's hand is extended. This position may correspond to an action associated with triggering the reader 200 such as, for example, reaching for an item to be read. The fingers 30 may become substantially straight when the user prepares to perform the associated action. As will be explained in further detail below, the straightening of the fingers and other motions resulting from the extension of the hand may comprise a triggering motion that results in a triggering of the reader 200. The triggering motion may be performed during a normal course of user activity. For example, the trigger motion may occur when the user reaches for an object (e.g., a package to be scanned). Thus, the triggering motion need not be intentionally performed with the purpose of effecting triggering. The triggering of the reader 200 can therefore be considered passive in nature.

The exemplary embodiments of the present invention described below will be explained with reference to the triggering motion shown in FIGS. 2A and 2B. However, those skilled in the art will understand that other triggering motions may be possible depending on where and/or how a device is worn. Thus, other embodiments may include triggering motions associated with the user's arm, leg, head, etc.

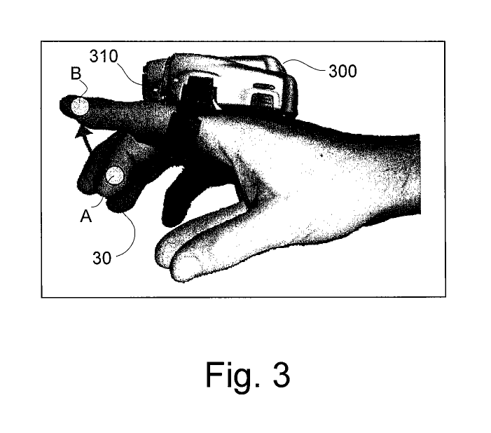

FIG. 3 shows an exemplary embodiment of a reader 300 according to the present invention. The reader 300 may be worn in a manner similar to that of the reader 200 and may include a triggering arrangement comprising a sensor (not shown) located within a distal portion 310 of a housing of the reader 300. According to the exemplary embodiment shown in FIG. 3, a triggering motion comprises moving the fingers 30 from a resting position A to a triggering position B. As the fingers 30 transition from the resting position to the triggering position, a distance between a distal end of the fingers 30 and the distal portion 310 decreases. In particular, the fingers 30 extend upwards into closer proximity with a base of the reader 300. This results in a decrease in a horizontal and/or a vertical distance between the fingers 30 and the base. The sensor may detect this change in proximity in any number of ways, as explained below.

One method of detecting the triggering motion is to implement the sensor as an optical sensor. For example, the sensor may be an infrared sensor positioned so that the fingers 30 cross a line of sight of the infrared sensor when in the triggering position. Depending on whether a detection of the horizontal or the vertical distance is desired, the sensor may be located at a front or a bottom portion of the reader 300. In other embodiments, optical sensor arrangements such as lasers and visible or near-infrared light sources may be used. In addition, in embodiments where the reader has existing optical sensing capabilities (e.g., a barcode reader), the sensor may utilize the existing capabilities. Thus, the sensor may not necessarily be a separate sensor. Further embodiments may include multiple sensors for detecting the horizontal and the vertical distances. Other detection methods may also be utilized in accordance with the present invention and will be readily apparent to those skilled in the art. For example, other embodiments may include ultrasonic, capacitive, magnetic and inductive sensors for measuring the proximity change of the fingers 30.

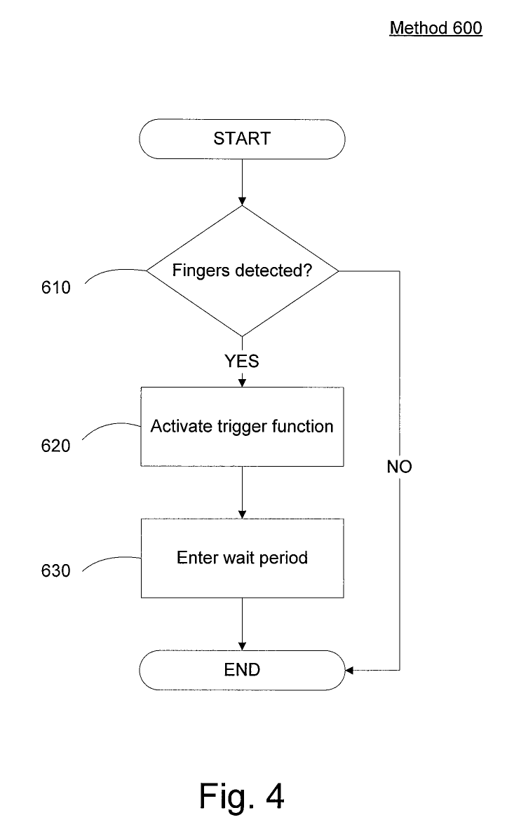

FIG. 4 shows an exemplary method 600 for activating the reader 300. The method 600 may be partially or entirely implemented in a control module of the reader 300. In step 610, the sensor determines whether the fingers 30 are detected. As previously described, the manner in which the fingers 30 are detected may vary depending on a particular implementation of the sensor.

In step 620, the sensor has detected the presence of the fingers 30 and activates a trigger function of the triggering arrangement. The trigger function produces an output signal that may be produced and received in the manner previously described with reference to the device 100. In response, a function module (e.g., an RF reading arrangement) of the reader 300 is activated.

After the function module is activated, the reader 300 may enter a wait period (step 630) in which the sensor is placed in an idle mode or temporarily deactivated. The wait period prevents accidental retriggering of the function module resulting from a continued presence of the fingers 30 and may be a predetermined duration. In some embodiments, the wait period may be user-programmable. After the wait period has elapsed, the sensor is reactivated and may resume detection of the fingers 30.

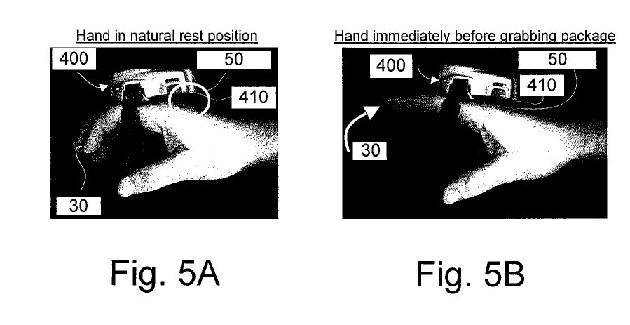

FIG. 5A shows an exemplary embodiment of a reader 400 in a resting position according to the present invention. As shown in FIG. 5A, when the reader 400 is worn in a manner similar to that of the device 200, a gap 50 exists between a bottom surface of a proximal portion 410 of the reader 400 and a back of the user's hand. The gap 50 may be a result of a relationship between a natural curvature of the hand and a predetermined shape and/or an orientation of the reader 400. The reader 400 may also include a sensor (not shown) disposed within a housing of the reader 400 and located at or about the proximal portion 410. The sensor may utilize any of the detection mechanisms associated with the sensor previously described with reference to FIG. 3, such as optical, magnetic, capacitive and inductive mechanisms.

FIG. 5B shows the reader 400 being activated in a manner similar to that of the device 200. For example, a triggering motion may comprise extending the hand between the resting position of FIG. 5A and a triggering position in which the fingers 30 are outstretched. As shown in FIG. 5B, when the reader 400 is in the triggering position, the gap 50 substantially decreases and the proximal portion 410 is brought into closer proximity to the back of the hand. The sensor may detect this change in proximity by, for example, measuring a change in distance between the proximal portion 410 and the back of the hand. The activation of the reader 400 will now be described.

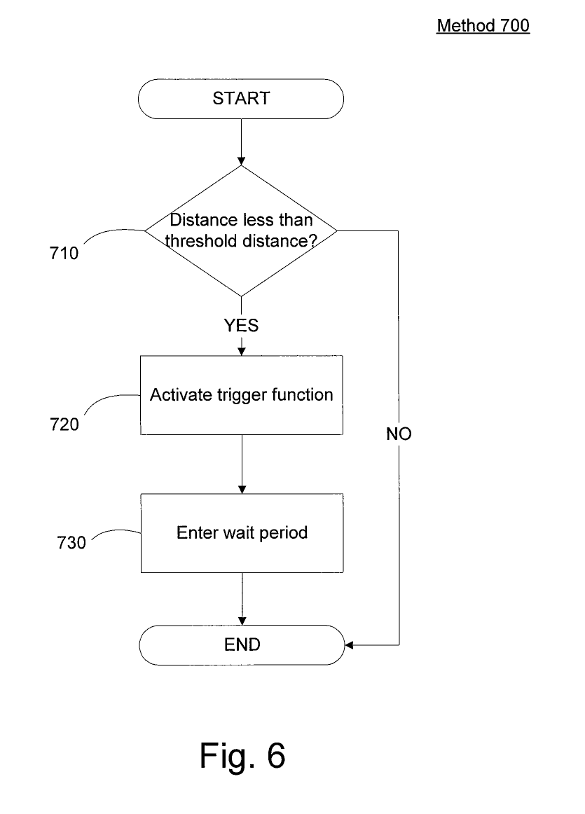

FIG. 6 shows an exemplary method 700 for activating the reader 400. The method 700 may be partially or entirely implemented in a control module of the reader 400. In step 710, the sensor measures the distance between the proximal portion 410 and the back of the hand. In some embodiments, the sensor may be an analog sensor that qualitatively measures the distance to the back of the hand. The sensor takes the measured distance and compares it (e.g., using a voltage comparator) to a reference (e.g., a reference voltage) that represents a threshold distance. The reference may be a function of one or more analog circuits, such as a resistive network. In other embodiments, the sensor may be a digital sensor that converts the measured distance into a digital value and compares it to a reference value stored in a memory. The reference voltage/value may also be user-determined to allow for adjustment of a sensitivity of the sensor. One or more reference values may be utilized, comprising a threshold value range for which triggering may occur.

In step 720, the distance is less than the threshold distance and the sensor activates a trigger function that produces an output signal activating a function module (e.g., an RF reading arrangement) of the reader 400. After the function module is activated, the reader 400 enters a wait period (step 730) to prevent accidental retriggering and to allow the function module to complete an operation (e.g., reading an RF tag).

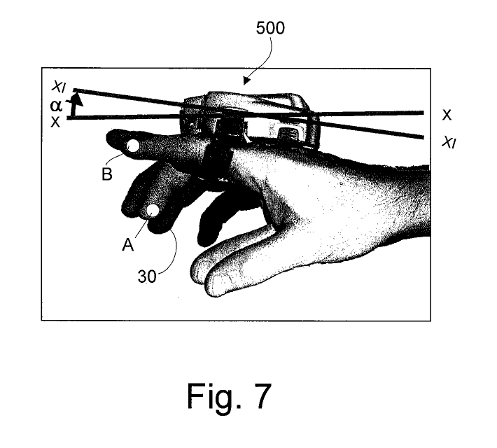

FIG. 7 shows an exemplary embodiment of a reader 500 according to the present invention. A function module of the reader 500 may be activated by a triggering motion substantially similar to the triggering motion previously described with reference to the reader 300. For example, the fingers 30 may bend away from the reader 500 when placed in the resting position A and may extend into closer proximity to the reader 500 when in the triggering position B. The reader 500 may include a sensor (not shown) disposed within a housing thereof. The sensor may detect a change in an orientation of the reader 500. Changes in orientation may be measured using an inertial sensing mechanism such as an accelerometer or a gyroscope. In one embodiment, the sensor may be a Micro-Electro-Mechanical Systems (MEMS) sensor comprising the accelerometer and/or the gyroscope. In other embodiments, traditional mechanical or electrical inertial sensors may be utilized depending on factors such as size, weight, cost, precision, reliability, etc.

The orientation change may be a shift in angle. As shown in FIG. 7, a longitudinal axis of the reader 500 may be substantially parallel to an initial plane denoted by a line X-X when the fingers 30 are in the resting position. The initial plane need not be a horizontal plane. Instead, the initial plane may be a predetermined plane or, alternatively, a plane corresponding to any orientation that the reader 300 recognizes as the resting position. Moving the fingers 30 to the triggering position causes the longitudinal axis to become parallel to a line XI-XI, which is oriented at an angle α to the line X-X. The orientation change may also comprise other types of displacement, such as horizontal or vertical translation. The sensor may detect the orientation change, compare a current orientation to a threshold value (e.g., an angular value) or a range of threshold values and activate the reader 500 accordingly. The activation of the reader 500 will now be described.

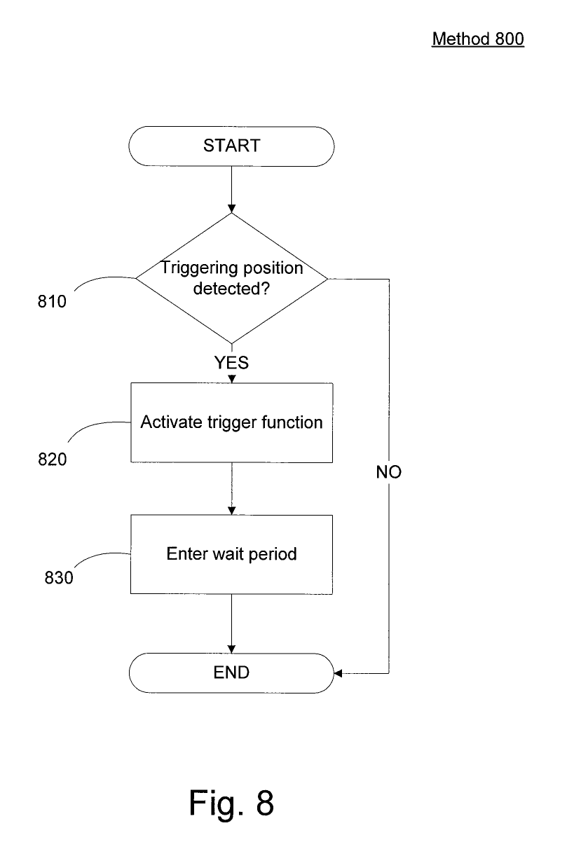

FIG. 8 shows an exemplary method 800 for activating the reader 500. The method 800 may be partially or entirely implemented in a control module of the reader 500. In step 810, the sensor determines whether the triggering position has been detected. This determination is based on the detection of the orientation change described above and may include one or more measurements of kinetic parameters such as acceleration, angle of orientation, momentum, etc. The measurements may be compared to a predetermined reference such as the angle α or initial orientation parameters of the reader 500.

In step 820, the triggering position has been detected and the sensor activates a trigger function that produces an output signal activating a function module (e.g., an RF tag reading arrangement) of the reader 500. After the function module is activated, the reader 500 enters a wait period (step 830) to prevent accidental retriggering and to allow the function module to complete an operation (e.g., receiving RF tag data).

The methods 600, 700 and 800 were described as utilizing a single triggering event. However, those skilled in the art will understand that it may also be possible to perform triggering by detecting a plurality of events, either sequentially or simultaneously. These events may include external events such as the triggering motion; initial, intermediate and final positions of the fingers 30; and internal events such as a logical state of the reader 300. Thus, the reader 300 may include a table or matrix of internal and/or external events that trigger one or more functions.

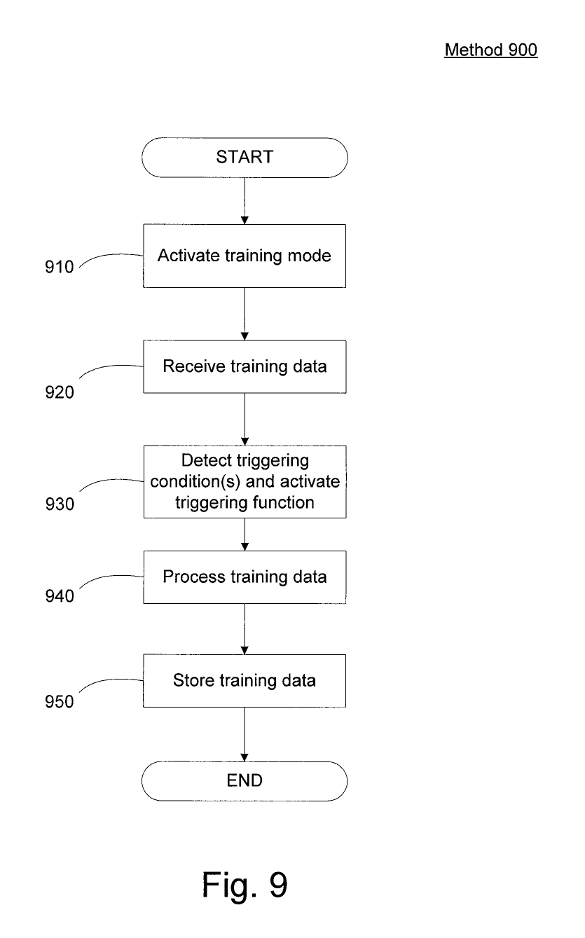

The methods of activating the readers 300, 400 and 500 were described as utilizing reference values (e.g., threshold value ranges) corresponding to predetermined parameters such as distance, acceleration, orientation, etc. These parameters were either user-determined or pre-configured (e.g., factory-set). However, it may also be possible to configure a reader to adjust to a user's specific triggering motion by learning parameters over time. An exemplary method 900 for training a reader is shown in FIG. 9 and will now be described with reference to the device 100.

In step 910, a training mode is activated. This step may be performed manually or automatically in response to detected changes in training data, which may include the predetermined parameters of distance, orientation, acceleration, etc. The training data is received by the trigger arrangement 140 (step 920) and stored in a memory (e.g., the memory 130). The receiving may be a continuous receiving of the training data. Alternatively, the trigger arrangement 140 may be configured to periodically sample the training data.

In step 930, the trigger arrangement 140 detects one or more triggering conditions (e.g., values of the predetermined parameters) and activates the triggering function using any of the methods previously described (e.g., the methods 600, 700 and 800). During this time, the trigger arrangement 140 may continue to receive new training data. As an alternative to detecting the triggering condition(s), the user may choose to manually indicate when triggering should occur. This is beneficial when the trigger arrangement 140 has difficulty detecting the triggering conditions.

In step 940, the control module 120 processes the training data. This may involve filtering out anomalous data values, characterizing the data (e.g., recognizing patterns or trends), compressing the data, and other data processing steps known to those skilled in the art.

In step 950, the processed training data is stored in a memory, such as the memory 130 or directly onto a memory of the trigger arrangement 140. Once the data is stored, the control module 120 can access the data for use in future triggering determinations. The data may supplement or replace the previous triggering condition(s). For example, the data may be used to gradually adjust the value of a predetermined parameter. If there is a substantial difference between the predetermined parameter and the data, the parameter value may be adjusted towards the data value. If the difference continues to occur over time (e.g., a trend is established), the parameter value may eventually approach or equal the data value.

As illustrated in the previously described embodiments, the present invention provides substantial benefits to the user. The triggering methods of the present invention enable the user to activate a mobile device without manually engaging a triggering mechanism. The triggering methods utilize natural triggering motions that the user would normally perform when operating the device. Thus, the user may continue to perform any tasks that he was previously engaged in. Over an extended period of use, this may represent a significant saving of time. One example of how the triggering motion may be seamlessly integrated into a task is when the user extends his hand in order to pick up an object. The extending is detected as a triggering motion and the object is read before the user makes contact with the object. The user then grabs the object and performs a task related thereto (e.g., placing it in a bag, stacking it, transferring it to another location, etc.). A second example is where the user's thumb is occupied by holding a writing instrument. The user may alternate between writing and reading without having to drop the instrument. If an object needs to be read, the user stops writing, directs his hand toward the object, thereby causing triggering of the device, and resumes writing as soon as the reading is complete.

In addition, by selecting a natural motion as the triggering motion, the present invention allows almost any user to activate the device. Users prone to repetitive stress injuries, arthritis, muscle cramping and other debilitating conditions may find that the present invention is more comfortable to use and less likely to cause or exacerbate injuries.

Yet another advantage of the present invention is the ability to adapt to the user. The training mode enables a device to adjust to particular motions of the user. Based on the device's past history, a sensitivity of the triggering arrangement can be automatically adjusted. In some embodiments, the device may store one or more user profiles containing triggering data of a specific user. Thus, the device may be shared amongst a plurality of users

The methods described above utilize triggering mechanisms based on a detection of a single event (e.g., motion of the fingers, motion of the device and motion of the back of the hand). These methods were described as capable of being combined to effect a triggering of independent functions. However, those skilled in the art will understand that these methods may also be combined to effect triggering of a specific function. For example, one embodiment may utilize both a detection of the fingers and a detection of the back of the hand. This may improve trigger accuracy and help eliminate false positives. If, for example, the detection based on the fingers indicates that triggering conditions have been met, but the detection based on the back of the hand shows a lack of sufficient triggering conditions, the specific function may not be triggered. Thus, the methods 600-800 may be performed in sequence or simultaneously to improve triggering and/or training accuracy. The methods 600-800 may also be implemented in combination with other triggering methods, such as conventional pushable buttons, audio triggers (e.g., finger snapping, clapping, whistling), etc. A plurality of triggering methods may be used collectively for triggering the reading of an RF tag or independently for triggering another function such as uploading tag data to a database, displaying information on a screen, triggering a barcode scanner, etc.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

1. A mobile device, comprising:
a function module; and
a triggering arrangement generating a signal to activate the function module in response to detecting a triggering condition, the triggering condition including a change in an orientation of the device regardless of a relative position between the device and a body part of a user with which the device is in contact.

2. The device of claim 1, wherein the triggering condition further includes a passive triggering motion of a user.

3. The device of claim 1, wherein the triggering condition further includes a time relative to a previous activation of the function module.

4. The device of claim 1, wherein the change in the orientation includes a change relative to a previous orientation of the device.

5. (canceled)

6. The device of claim 1, wherein the function module includes at least one of an RFID) reader, a laser-based scanner, an imager and a display.

7. The device of claim 1, wherein the triggering arrangement detects the triggering condition by comparing a value corresponding to the change in the orientation and a threshold value range.

8. The device of claim 7, wherein the threshold value range is determined as a function of a training data set.

9. The device of claim 1, wherein the triggering arrangement enters a predetermined wait period after generating the signal.

10. The device of claim 1, wherein the triggering arrangement includes a sensor, the sensor including at least one of an optical sensor, a magnetic sensor, a capacitive sensor, an inductive sensor, an ultrasonic sensor and an inertial sensor.

11. The device of claim 1, wherein the device is a wearable device.

12. A method, comprising:
detecting a triggering condition, the triggering condition including a change in an orientation of a mobile device regardless of a relative position between the device and a body part of a user with which the device is in contact; and
generating a signal to activate a function of the device in response to detecting the triggering condition.

13. The method of claim 12, further comprising:
activating the function.

14. The method of claim 12, wherein the triggering condition includes a passive triggering motion of the user.

15. The method of claim 12, wherein the triggering condition further includes a change in an orientation of the device relative to a previous orientation of the device.

16. The method of claim 15, wherein the change in the orientation relative to a previous orientation of the device includes a change in an angular orientation of the device.

17. The method of claim 12, wherein the detecting step includes comparing a value corresponding to the change in the orientation and a threshold value range.

18. The method of claim 17, further comprising:
generating the threshold value range as a function of a training data set.

19. The method of claim 12, further comprising:
entering a predetermined wait period after generating the signal.

20. A mobile device, comprising:
a function means for performing a data capture function; and
a triggering means for generating a signal to activate the function means in response to detecting a triggering condition, the triggering condition including a change in an orientation of the device regardless of a relative position between the device and a body part of a user with which the device is in contact.
